(19) United States
(12) Patent Application Publication
(10) Pub. No.: US 2012/0000037 A1
(43) Pub. Date: Jan. 5, 2012

(54) Grip

(76) Inventors: Chi-Yuan Chen, Taipei (TW); Noriyoshi Nagaki, Osaka (JP)

(21) Appl. No.: 13/137,727

(22) Filed: Sep. 8, 2011

(30) Foreign Application Priority Data
Apr. 14, 2010 (TW) 099206721
Apr. 15, 2010 (CN) 201020160193.4

(51) Int. Cl. F16G 11/10; B25G 1/10

(52) U.S. Cl. 24/134 N; 16/421

(57) ABSTRACT

A grip (100) for gripping a wire (L) includes a body (10) comprising an upper jaw (11) extending laterally, a pivot section (12) depending from one end of the upper jaw (11), and a sleeve section (13) depending from the other end of the upper jaw (11), the sleeve section (13) including a slot (131) at one end; a pivotal link (20) pivotably secured to the pivot section (12); a gripping seat (40) pivotably secured to the pivotal link (20) and comprising a jaw member (41) disposed below the upper jaw (11); and a lever (30) inserted through the slot (131) and having one end pivotably secured to the pivotal link (20) and a ring (32) at the other end. The ring (32) is positioned at an angle θ with respect to a longitudinal center line (110) of the wire (L) passing through the upper jaw (11).

### BACKGROUND OF THE INVENTION

1. Field of the Invention

The invention relates to wire gripping tools and more particularly to a grip for use in a wire pulling operation.

2. Description of Related Art

A conventional grip 900 is shown in FIG. 1 and comprises an upper jaw 911, a lower jaw 912 with a wire L gripped therebetween, the lower jaw 912 provided besides a pivotal link 92, and a lever 93 passing through a slot 913 of a sleeve section to have one end pivotably secured to one end of the pivotal link 92 and the other end being formed as a ring 931.

FIG. 1A is a sectional view taken along line A-A of FIG. 1 showing center of the wire L spaced from center of the ring 931 by a distance D1.

In a wire gripping operation as shown in FIGS. 2 and 2A, a hook H of a chain attached to a winch (not shown) or the like is connected to the ring 931. Next, the winch exerts a force to pull the ring 931 as indicated by arrows. As a result, the wire L is gripped by the upper jaw 911 and the lower jaw 912.

However, the gripped wire L may be bent at one end of the upper jaw 911 because the pulling force of the winch is not aligned with center of the wire L due to the distance D1 between center of the wire L and center of the ring 931. To the worse, the material structure of wire L may be substantially damaged (as shown in FIG. 2A) to greatly lower its performance.

Thus, the need for improvement still exists.

### SUMMARY OF THE INVENTION

It is therefore one object of the invention to provide a grip for gripping a wire comprising a body comprising an upper jaw extending laterally, a pivot section depending from one end of the upper jaw, and a sleeve section depending from the other end of the upper jaw, the sleeve section including a slot at one end; a pivotal link pivotably secured to the pivot section; a gripping seat pivotably secured to the pivotal link and comprising a jaw member disposed below the upper jaw; and a lever inserted through the slot and having one end pivotably secured to the pivotal link and a ring at the other end; wherein the ring is at an angle θ with respect to a longitudinal center line of the wire passing through the upper jaw and the lower jaw and the ring is disposed at one side of the wire.

The invention has the following advantages as compared with the prior art grip:

A ring at one end of a lever is at an acute angle with respect to a longitudinal center line of a wire passing through an upper jaw and a lower jaw and the ring for pulling the wire is disposed at one side of the wire. This has the benefits of exerting a great force on the wire when pulling the grip at the ring, and positively preventing the wire from being bent or otherwise damaged.

No additional components are added. No complicated manufacturing processes are required. Materials for manufacturing the invention are reduced. Most importantly, it is safe, reliable, and durable.

The above and other objects, features and advantages of the invention will become apparent from the following detailed description taken with the accompanying drawings.

### BRIEF DESCRIPTION OF THE DRAWINGS

FIG. 1 is a side view of a conventional grip with a wire being gripped by its jaws;

FIG. 1A is a sectional view taken along line A-A of FIG. 1 showing center of the wire spaced from center of the hole by a distance D1;

FIG. 2 is a view similar to FIG. 1 showing the wire being bent after pulling the ring attached by a hook at one end of a chain and pulled by a winch;

FIG. 2A is a side elevation showing the bent wire of FIG. 2;

FIG. 3 is a perspective view of a grip according to a preferred embodiment of the invention;

FIG. 4 is an exploded perspective view of FIG. 3;

FIG. 5 is a top view of FIG. 3 with a wire being gripped in use;

FIG. 6 is side elevation of FIG. 5;

FIG. 6A is a sectional view taken along line A-A of FIG. 6 showing center of the wire spaced from center of the hole by a distance D2;

FIG. 6B is a rear view of FIG. 5;

FIG. 6C is an enlarged view of FIG. 6B showing an allowable angle range of the ring with respect to the wire;

FIG. 6D is an enlarged view of FIG. 6B showing an optimum angle range of the ring with respect to the wire; and

FIG. 7 is a view similar to FIG. 6 showing the ring attached by a hook at one end of a chain and pulled by a device.

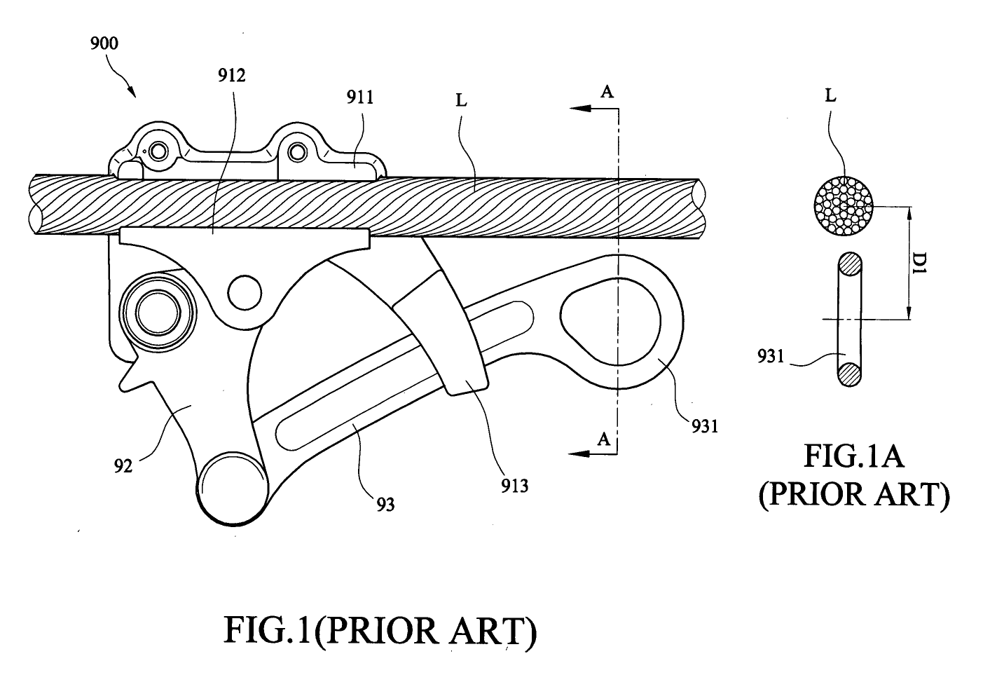

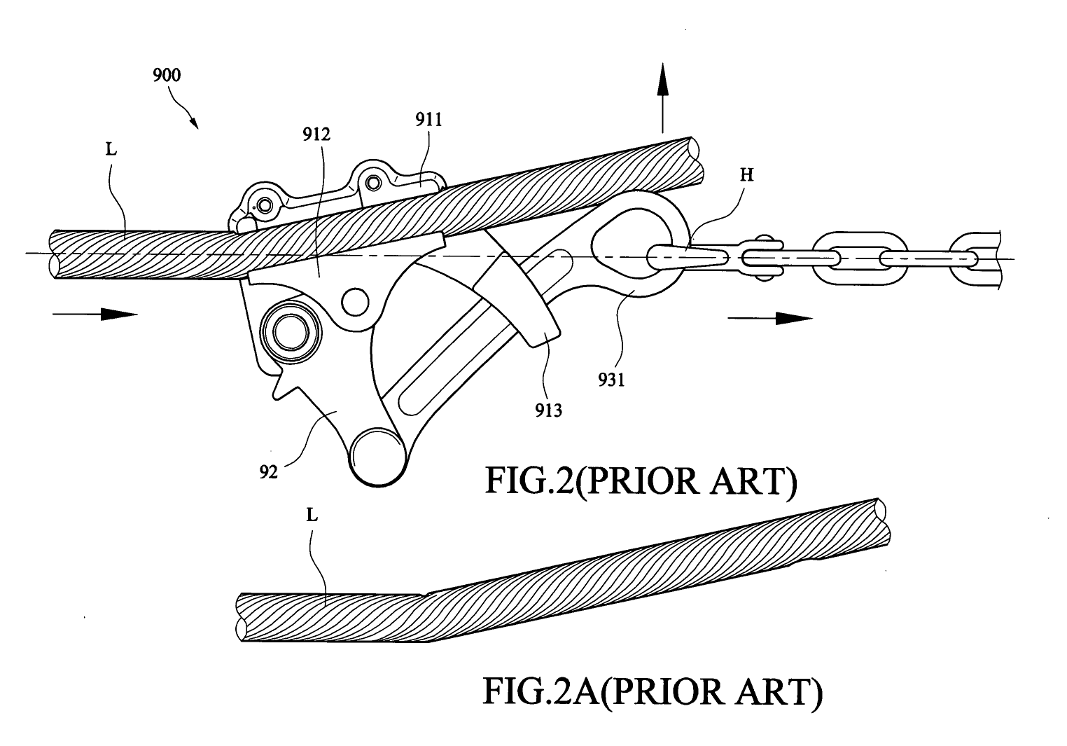

### DETAILED DESCRIPTION OF THE INVENTION

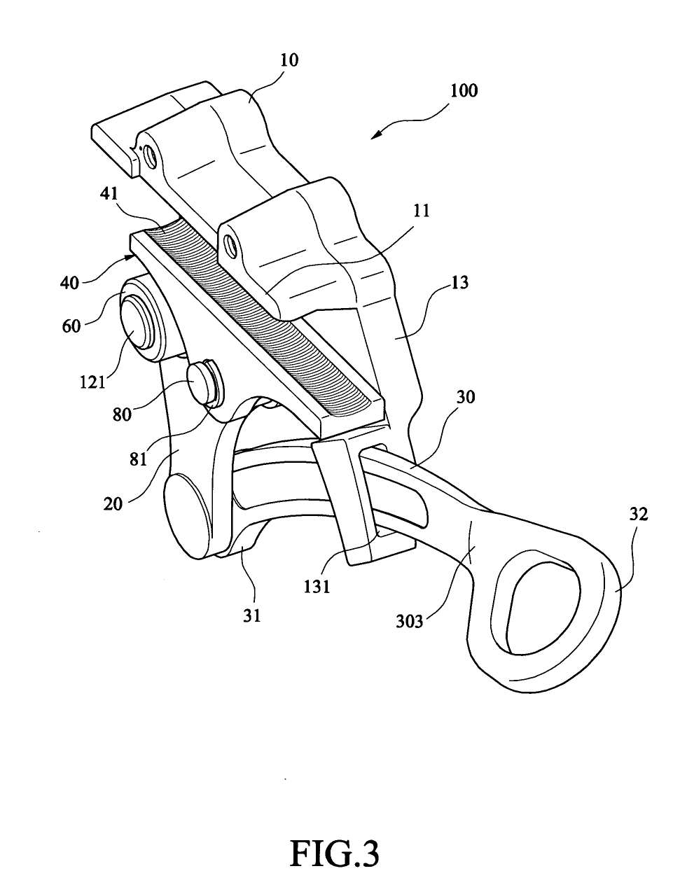

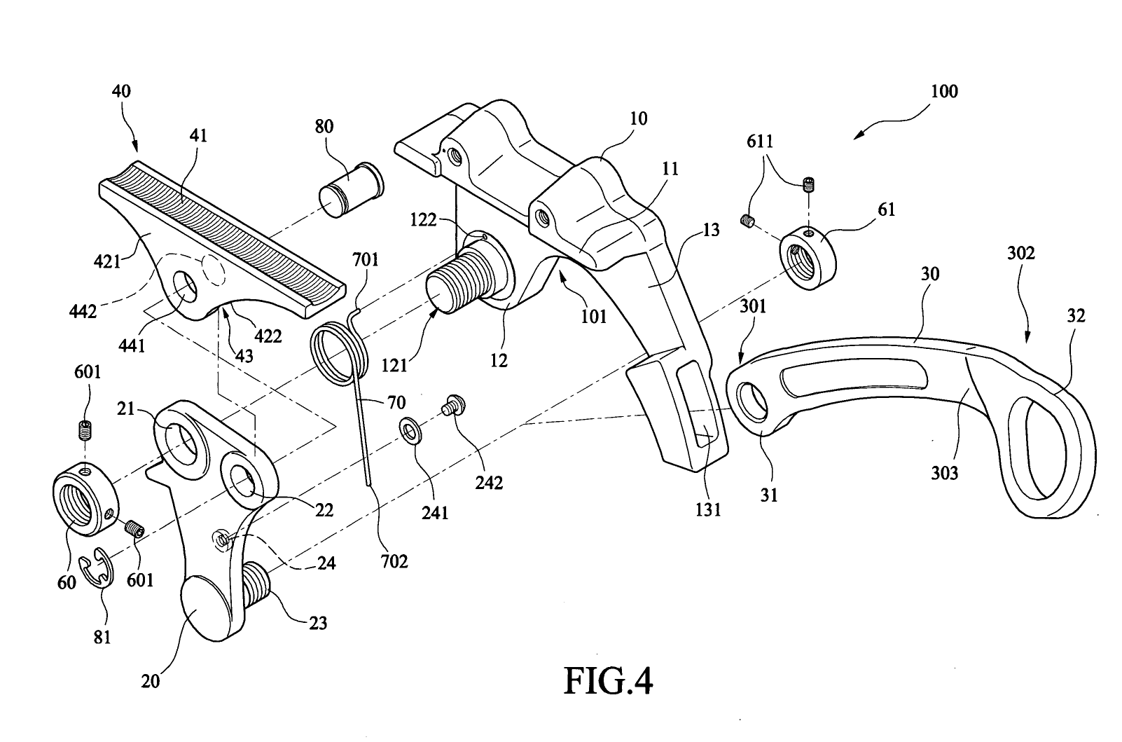

Referring to FIGS. 3 to 7, a grip 100 in accordance with a preferred embodiment of the invention comprises a body 10, a pivotal link 20, a lever 30, and a gripping seat 40 each discussed in detail below.

The body 10 comprises a curved bottom recess 101, an upper jaw 11 extending laterally, a pivot section 12 provided on one side of the recess 101 and including an externally threaded projection 121 projecting laterally and a positioning hole 122 on an enlarged base of the externally threaded projection 121 into the body 10, and a sleeve section 13 including a slot 131 of rectangular cross-section at one end.

The substantially triangular pivotal link 20 comprises a first hole 21 at a first corner, a second hole 22 at a second corner, an externally threaded protrusion 23 at a third corner, and a threaded bossed hole 24 between the externally threaded protrusion 23 and the second hole 22.

The curved lever 30 comprises one holed end 301, the other holed end (i.e., free end) 302, a positioning hole 31 at one end, a bent marking portion 303 proximate the other end, and a ring 32 at the other end (i.e., at the other side of the bent marking portion 303). The ring 32 is at an acute angle with respect to the remaining portion of the lever 30 at one side of the bent marking portion 303.

The bifurcated gripping seat 40 comprises an elongated knurled jaw 41 on a top, two parallel plates 421, 422 depending downward from both sides of the jaw 41 respectively, a groove 43 defined between and by the parallel plates 421, 422, and two aligned through holes 441, 442 in the parallel plates 421, 422 respectively.

Assembly of the invention will be described in detail below.

A torsion spring 70 is put on the externally threaded projection 121 with one end 701 inserted into the positioning hole 122 for positioning.

The first hole 21 is put on the externally threaded projection 121 to engage with a portion of the externally threaded projection 121 joining the body 10 and the other end 702 of the spring 70 urges against an outer surface of the threaded bossed hole 24. A screw 242 is driven through a washer 241 into the threaded bossed hole 24 to fasten the other end 702 of the spring 70. Next, a nut 60 is threadedly put on the externally threaded projection 121. Finally, two threaded fasteners 601, 601 are driven through the nut 60 to pivotably secure the nut 60 to the externally threaded projection 121.

The lever 30 is inserted through the slot 131 until one holed end 301 passes the slot 131. Next, the positioning hole 31 is put on the protrusion 23. Next, a nut 61 is threadedly put on the externally threaded protrusion 23. Finally, two threaded fasteners 611, 611 are driven through the nut 61 to pivotably secure the nut 61 to the externally threaded protrusion 23. The pivotal link 20 is thus pivotably interconnected the body 10 and the lever 30.

The grove 43 of the gripping seat 40 is put on the second corner of the pivotal link with the second hole 22 aligned with the through holes 441, 442. Next, a pivot pin 80 is driven through one through hole 442, the second hole 22, and the other through hole 441. Finally, a C-shaped retaining ring 81 is tightly put on an end of the pivot pin 80 to pivotably fasten the pivotal link 20 and the gripping seat 40 together. The jaw 41 is defined as a lower jaw 41.

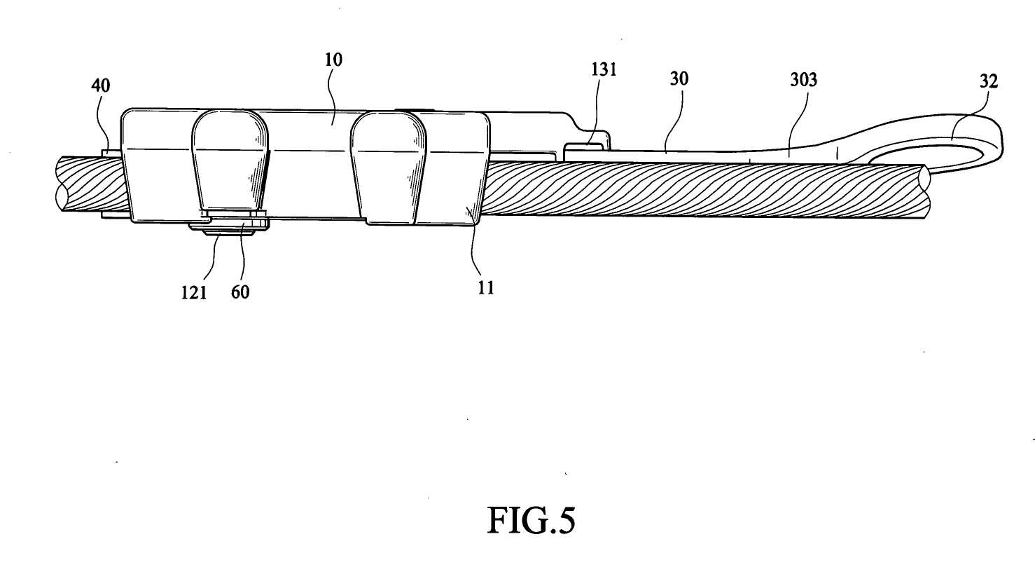

An operation of the invention will be described in detailed below by referring to FIGS. 5 to 7 specifically.

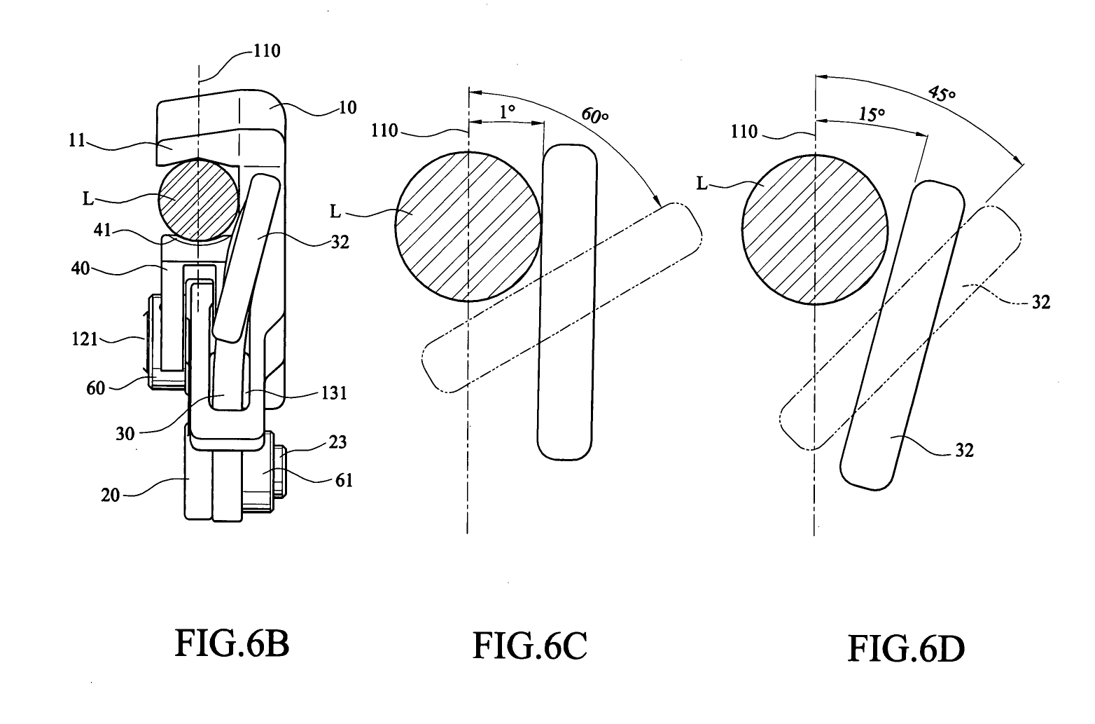

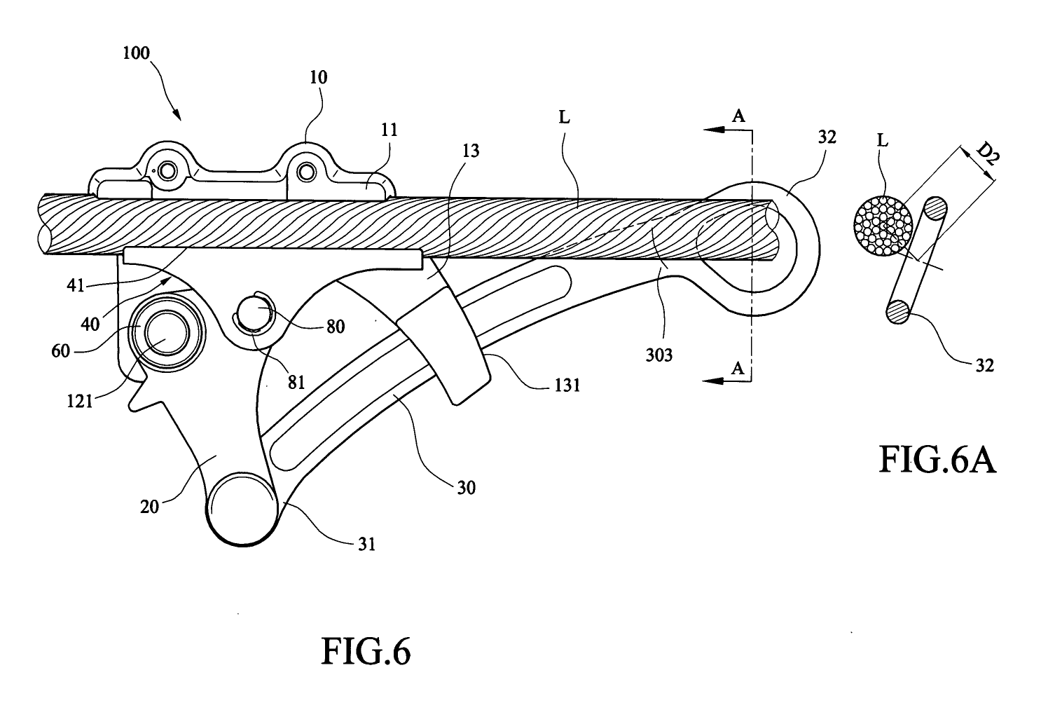

A user may insert a wire L through a space defined between the upper jaw 11 and the lower jaw 41. The ring 32 is besides the wire L (see FIG. 6). The ring 32 is at angle with respect to the wire L (see FIG. 6A). Center of the wire L is separated from center of the ring 32 by a distance D2. It is noted that the distance D2 is much less than the distance D1 of the prior art described in the background paragraph of the invention.

As shown in FIG. 6B, the ring 32 is at an angle with respect to a longitudinal center line 110 of the wire L passing through the upper jaw 11 and the lower jaw 41. As shown in FIG. 6C, the ring 32 is at an angle in a range between 1-degree and 60-degree with respect to a center line 110 of the wire L as preferred by the invention. As shown in FIG. 6D, the ring 32 is at an angle in a range between 15-degree and 45-degree with respect to the center line 110 of the wire L as more preferred by the invention.

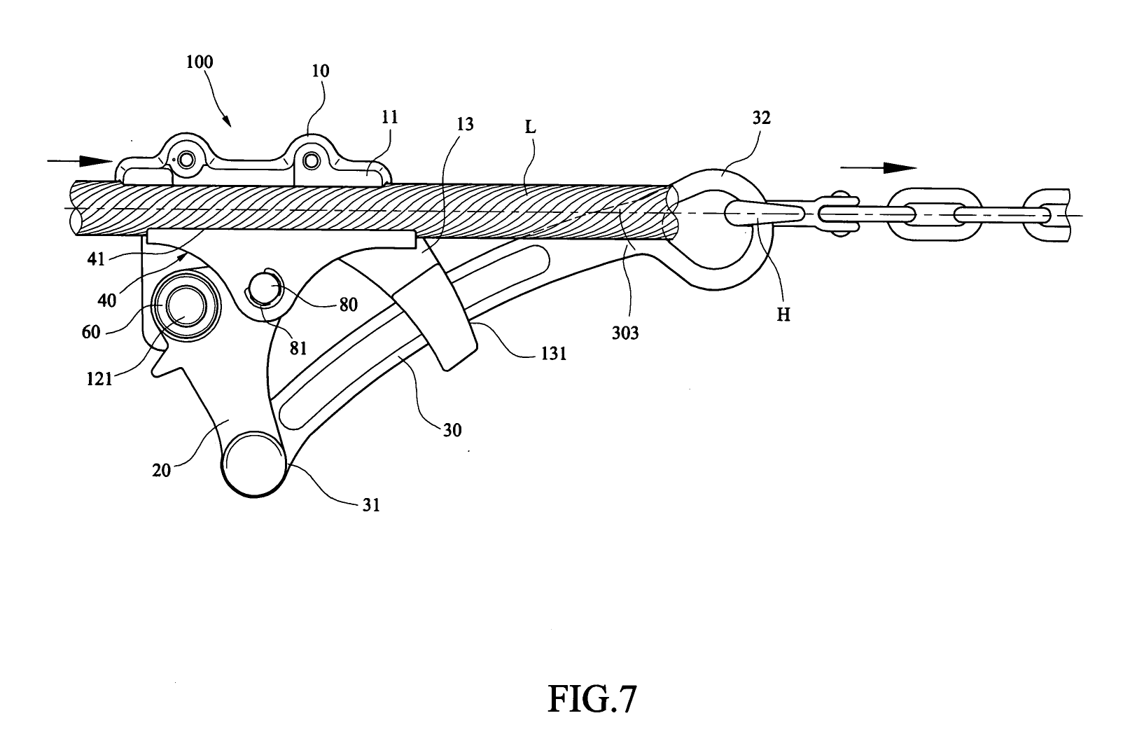

A wire pulling operation of the invention will be described in detail below by referring to FIG. 7. First attach a hook H at one end of a chain to the ring 32. Next, activate a pulling device to pull the chain and thus the ring 32. Preferably, the wire L will not be bent or otherwise damaged because the ring 32 is besides the wire L with a minimum distance D2 therebetween (see FIG. 6A).

Advantageously, center of the pulling force is at a minimum angle with respect to center line of wire L (see FIG. 7). Hence, a substantial portion of the pulling force is exerted on the wire L via the jaws 11, 41. This has the benefits of decreasing the possibility of bending and/or twisting the wire L to a minimum, and thus positively preventing the wire L from being damaged.

While the invention has been described in terms of preferred embodiments, those skilled in the art will recognize that the invention can be practiced with modifications within the spirit and scope of the appended claims.

What is claimed is:

1. A grip (100) comprising a lever (30) including a ring (32) at one end wherein the ring (32) is at an angle θ with respect to the remaining portion of the lever (30).

2. The grip (100) of claim 1, wherein the angle θ ranges between 1-degree and 60-degree.

3. The grip (100) of claim 2, wherein the angle θ ranges between 15-degree and 45-degree.

4. A grip (100) for gripping a wire (L) comprising:
a body (10) comprising an upper jaw (11) extending laterally, a pivot section (12) depending from one end of the upper jaw (11), and a sleeve section (13) depending from the other end of the upper jaw (11), the sleeve section (13) including a slot (131) at one end;
a pivotal link (20) pivotably secured to the pivot section (12);
a gripping seat (40) pivotably secured to the pivotal link (20) and comprising a jaw member (41) disposed below the upper jaw (11); and
a lever (30) inserted through the slot (131) and having one end pivotably secured to the pivotal link (20), the lever (30) comprising a ring (32) at the other end;
wherein the ring (32) is positioned at an angle θ with respect to a longitudinal center line (110) of the wire (L) passing through the upper jaw (11) and the lower jaw (41) and the ring (32) is disposed at one side of the wire (L).

5. The grip (100) of claim 4, wherein the angle θ ranges between 1-degree and 60-degree.

6. The grip (100) of claim 5, wherein the angle θ ranges between 15-degree and 45-degree.

7. The grip (100) of claim 4, wherein the ring (32) is bent away from one side of the upper jaw (11).

8. The grip (100) of claim 4, wherein the lever (30) is curved.
